(19) United States
(12) Patent Application Publication
(10) Pub. No.: US 2002/0077849 A1
(43) Pub. Date: Jun. 20, 2002

(54) System and method for improving efficiency of health care

(76) Inventors: Howard M. Baruch, Englewood, NJ (US); Lawrence Baruch, New York, NY (US)

Correspondence Address: BRADLEY J. MEIER, ESQ., KENYON & KENYON, 1500 K STREET, N.W., SUITE 700, WASHINGTON, DC, 20005, US

(21) Appl. No.: 09/737,797

(22) Filed: Dec. 18, 2000

Related U.S. Application Data
(60) Provisional application No. 60/178,892, filed on Jan. 28, 2000.

(51) Int. Cl. G06F 17/60

(52) U.S. Cl. 705/2

(57) ABSTRACT

A centralized system that integrates the patient, physician, and payer in providing timely information through a direct communication channel while promoting health care practitioners' adherence to national guidelines in prevention and treatment of disease. This system provides real time feedback, quality assurance and goals to the patient and health care provider, among others (e.g., insurer, employer, etc.). Outside information, such as medical test results and fitness data, are easily incorporated into the health care repository, and the information collected on each patient allows for direct marketing of pharmaceuticals to the physicians and/or patients based on their needs, serves as a reminder and educational system for patients and health care providers, identifies patients for clinical trials, and incorporates relevant new information into the individual care of the patient.

### CROSS-REFERENCE TO RELATED APPLICATION

This application claims the benefit under 35 U.S.C. §119(e) of U.S. Provisional Application No. 60/178,892, filed Jan. 28, 2000.

### FIELD OF THE INVENTION

The present invention relates to a system and method for integrating the components of the health care industry.

### COPYRIGHT NOTICE

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

The inefficiencies experienced by Corporate America, physicians, and health care facilities costs billions of dollars. The existing health care system is based upon inefficiency and is not concerned with reducing cost through immediate payment. For example, insurance companies have financial incentives to not pay bills and to operate on a spread in order to increase their own revenue streams and prolong facility and physician payments.

FIG. 1a, FIG. 1b and FIG. 2 illustrate this inefficiency through the example of a worker's compensation claim to a self-insured company. When an employee of a company is injured (step 100), an employer fills out a first report of injury form detailing the circumstances of the injury (step 102). The employer sends associated forms to the insurer and the state (step 104), and a supervisor in the company notifies a review company (e.g., a Third Party Administrator (“TPA”) who handles worker's compensation claims on behalf of the company) about the claim within 24 hours (step 106).

If emergency hospitalization is required (step 108), then a concurrent review is undertaken by the review company (step 110). The injured employee's discharge needs are assessed (step 112) and a treating physician is contacted (step 114). The injured employee is later discharged from the hospital (step 116). If emergency hospitalization is not required (step 108), the injured employee is contacted (step 118) and directed to a PPO (Preferred Provider Organization) physician (step 120), after which time the injured employee and health care provider have continuous contact (step 122). Feed back is generated to the company, insurer and provider (step 124).

If catastrophic case management is required and approved (step 126), then RN (Registered Nurse) case management is assigned (step 128), along with TCM (Telephonic Case Management) activities (step 130). This process is an attempt to assure cost effective treatment, settings and approaches (step 132), and on-site case management is commenced if indicated (step 134). If catastrophic case management is not required and approved (step 126), then the injured employee's outpatient treatment is monitored (step 136), and an IME (Independent Medical Examination) could be coordinated (step 138).

If the injured employee can be returned to work (step 140), the type of work and recovery period for the employee is assessed (step 142), the physician submits bills for services rendered (step 144), the provider bill is taken through audits and PPO reduction (step 146), and the case is closed (step 148). If the injured employee cannot be returned to work (step 140), a determination is made as to whether the injured employee requires a new position or new job (step 150). If a new position or job is required, the injured employee is referred to vocational counseling (step 152).

FIG. 2 continues this illustration from the perspective of the billing and collections process. After the injured employee receives medical care (step 200), the provider submits the bills to a claims office in the company (step 205), which forwards the bills to the TPA (step 210). Once the incoming bills are received by the TPA (step 215), the bills are batched and given to bill analysts (step 220). Data entry of the bills by a nurse analyst begins (step 225), and after data entry the bills are sent through a bill analysis program (step 230).

A claims review alert is usually triggered when bills remain unpaid through 30 days of treatment or loss time. If the claims review alert is triggered (step 235), the insurance carrier is notified of the need for a utilization review (step 265). Upon authorization, a nurse or doctor performs the utilization review (step 270). In the course of the utilization review, agreed upon treatment time frames are obtained from the attending doctor (step 275). If agreement is not obtained with the attending doctor concerning treatment time frames, a peer to peer review is set up in that zip code area (step 280).

If the claims review alert is not triggered (step 235), batched bills are audited by a second nurse analyst for possible record review and negotiated reductions (step 240). This secondary audit is to insure that the primary condition for which the patient is treated is billed. (In some cases, a patient enters the hospital for a primary condition and has treatment for another problem that has a higher billing code. In this case the hospital may claim that the secondary problem is the primary reason the patient is in the hospital, in order to receive a higher fee.) Any errors found are corrected (step 245), and an explanation of benefits are printed by batched and matched bills (step 250). Bills are then posted to history or archived, with non-compliant providers identified and noted to history (step 255). The bills are then returned to the claims office for payment (step 260).

Continuing the illustration of inefficiency in the worker's compensation/self-insured company field, it is recognized that an employer pays many times the injured employee's treatment cost to cover costs for temporary help, productivity loss, training and administration, among other things. Current systems do not address and are unable to address these secondary and expensive indirect costs, due to lack of communication limitations. Corporations need real2 time communications with physicians and facilities to efficiently integrate the employees needs with the corporation's requirements. Additionally, the corporations must be assured a high level of patient satisfaction and quality of care.

In addition to the illustrated efficiencies, cardiovascular disease continues to be the leading cause of mortality and morbidity in the United States. The approach to prevention and treatment of cardiovascular disease is generally based on data generated from large-scale clinical trials with mortality as one of the major endpoints. To assist health care practitioners in their integration of new information into clinical practice, professional organizations such as the American Heart Association and American College of Cardiology periodically develop new and update existing guidelines to promote evidence-based standards of care. Despite the comprehensive nature and widespread dissemination of these guidelines, primary and secondary prevention strategies are not being implemented in the majority of individuals and patients are not being optimally managed. Healthcare providers need to address the underutilization of healthcare interventions, which have been proven to reduce the risk of morbidity and mortality. Patients are often not aware of their individual treatment strategies, or goals.

Accordingly, there is a need in the art for a virtually integrated disability management system that integrates the patient, physician, and payer into a centralized system that provides timely information through a direct communication channel. Within this virtual physicians network, patients receive expeditious and high quality health care, and health care practitioners' adherence to national guidelines in prevention and treatment of disease are examined, while providing real time feedback, quality assurance and goals to the patient and health care provider, among others (e.g., insurer, employer, etc.). All costs incurred by and due to patients are reduced in such a system, not just the medical costs.

### SUMMARY OF THE INVENTION

The present invention is directed to improving the efficiency of health care by integrating the patient, physician, and payer into a centralized system that provides timely information through a direct communication channel, while promoting health care practitioners' adherence to national guidelines in prevention and treatment of disease. This system provides real time feedback, quality assurance and goals to the patient and health care provider, among others (e.g., insurer, employer, etc.). Outside information, such as medical test results and fitness data, are easily incorporated into the health care repository, and the information collected on each patient allows for direct marketing of pharmaceuticals to the physicians and/or patients based on their needs, serves as a reminder and educational system for patients and health care providers, identifies patients for clinical trials, and incorporates relevant new information into the individual care of the patient.

### BRIEF DESCRIPTION OF THE DRAWINGS

FIG. 1a and FIG. 1b is a flowchart of steps illustrating a worker's compensation managed care process.

FIG. 2 is a flowchart of step illustrating a billing and collections process associated with a self-insured company.

FIG. 3 depicts a client computer in accordance with an exemplary embodiment of the present invention.

FIG. 4 depicts a network architecture in accordance with an exemplary embodiment of the present invention.

FIG. 5 depicts tables of a relational database in accordance with an exemplary embodiment of the present invention.

FIG. 6 is a flowchart of steps illustrating the use of a health care repository in accordance with an exemplary embodiment of the present invention.

FIG. 7 depicts a server application receiving medical exam information in accordance with an exemplary embodiment of the present invention.

FIG. 8 depicts a server application receiving spinal exam information in accordance with an exemplary embodiment of the present invention.

FIG. 9 depicts a server application receiving spinal exam information in accordance with an exemplary embodiment of the present invention.

FIG. 10 depicts a server application receiving operation information in accordance with an exemplary embodiment of the present invention.

FIG. 11 depicts a server application summarizing operation information in accordance with an exemplary embodiment of the present invention.

FIG. 12 depicts a server application's disposition form in accordance with an exemplary embodiment of the present invention.

FIG. 13 depicts a server application's status report in accordance with an exemplary embodiment of the present invention.

FIG. 14 depicts a server application compiling insurance codes for a bill in accordance with an exemplary embodiment of the present invention.

FIG. 15 depicts a server application generated worker's compensation report in accordance with an exemplary embodiment of the present invention.

FIG. 16 depicts a server application's screening ability in accordance with an exemplary embodiment of the present invention.

FIG. 17 is a flowchart of steps illustrating the logic of a server application in accordance with an exemplary embodiment of the present invention.

FIG. 18 depicts an introductory screen of a server application in accordance with an exemplary embodiment of the present invention.

FIG. 19 depicts a disease entity screen of a server application in accordance with an exemplary embodiment of the present invention.

FIG. 20 depicts a treatment strategy screen of a server application in accordance with an exemplary embodiment of the present invention.

FIG. 21 depicts a disease entity screen of a server application in accordance with an exemplary embodiment of the present invention.

FIG. 22 depicts a disease entity screen of a server application in accordance with an exemplary embodiment of the present invention.

FIG. 23 depicts a disease entity screen of a server application in accordance with an exemplary embodiment of the present invention.

FIG. 24 depicts a disease entity screen of a server application in accordance with an exemplary embodiment of the present invention.

FIG. 25 depicts a treatment strategy screen of a server application in accordance with an exemplary embodiment of the present invention.

FIG. 26 depicts a treatment strategy screen of a server application in accordance with an exemplary embodiment of the present invention.

FIG. 27 depicts a summary page of a server application in accordance with an exemplary embodiment of the present invention.

FIG. 28 depicts a disease entity screen of a server application in accordance with an exemplary embodiment of the present invention.

FIG. 29 depicts a treatment strategy screen of a server application in accordance with an exemplary embodiment of the present invention.

FIG. 30 depicts a treatment strategy screen of a server application in accordance with an exemplary embodiment of the present invention.

FIG. 31 depicts a summary page of a server application in accordance with an exemplary embodiment of the present invention.

FIG. 32 depicts a disease entity screen of a server application in accordance with an exemplary embodiment of the present invention.

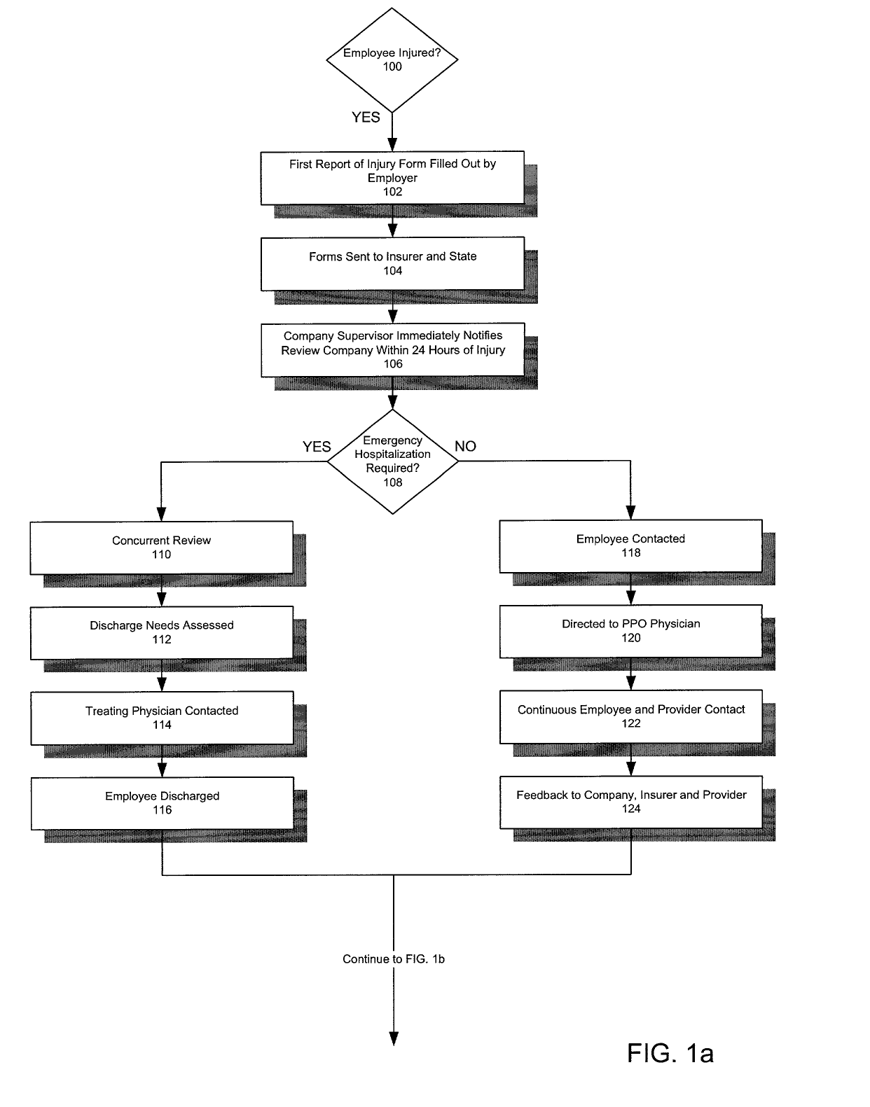

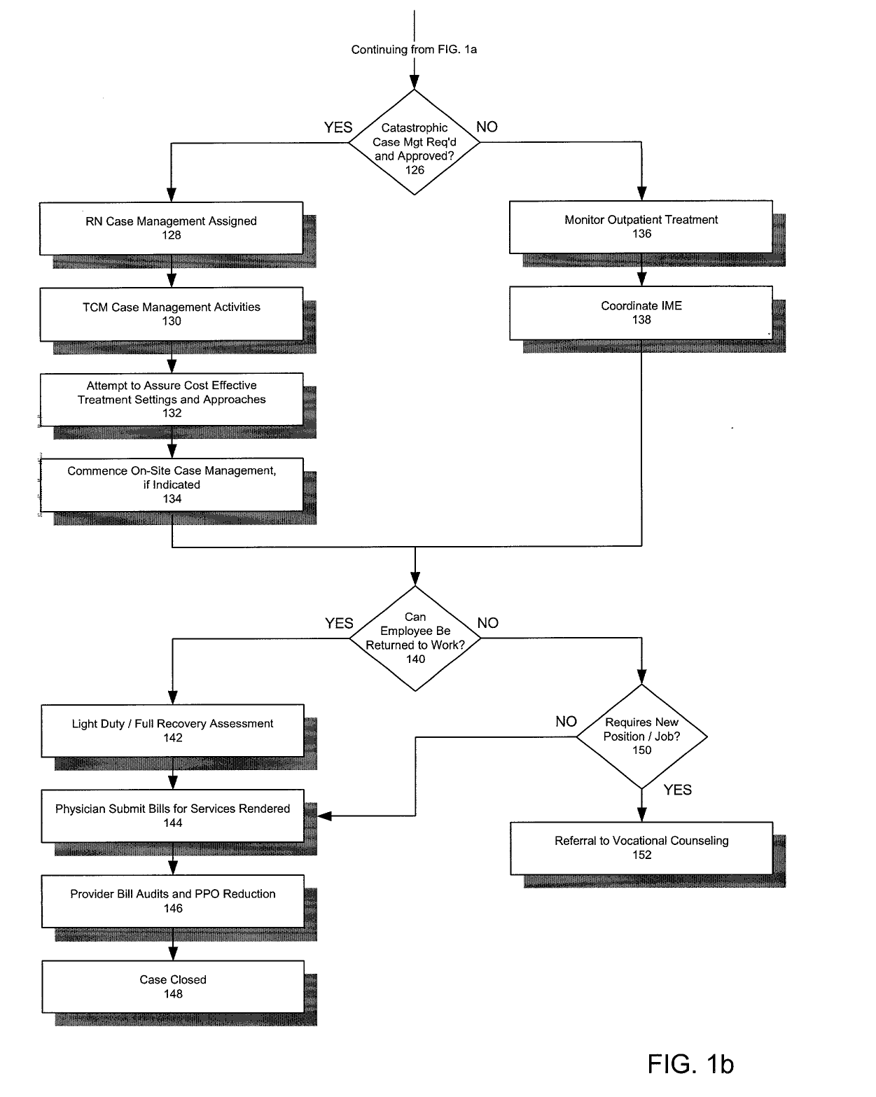

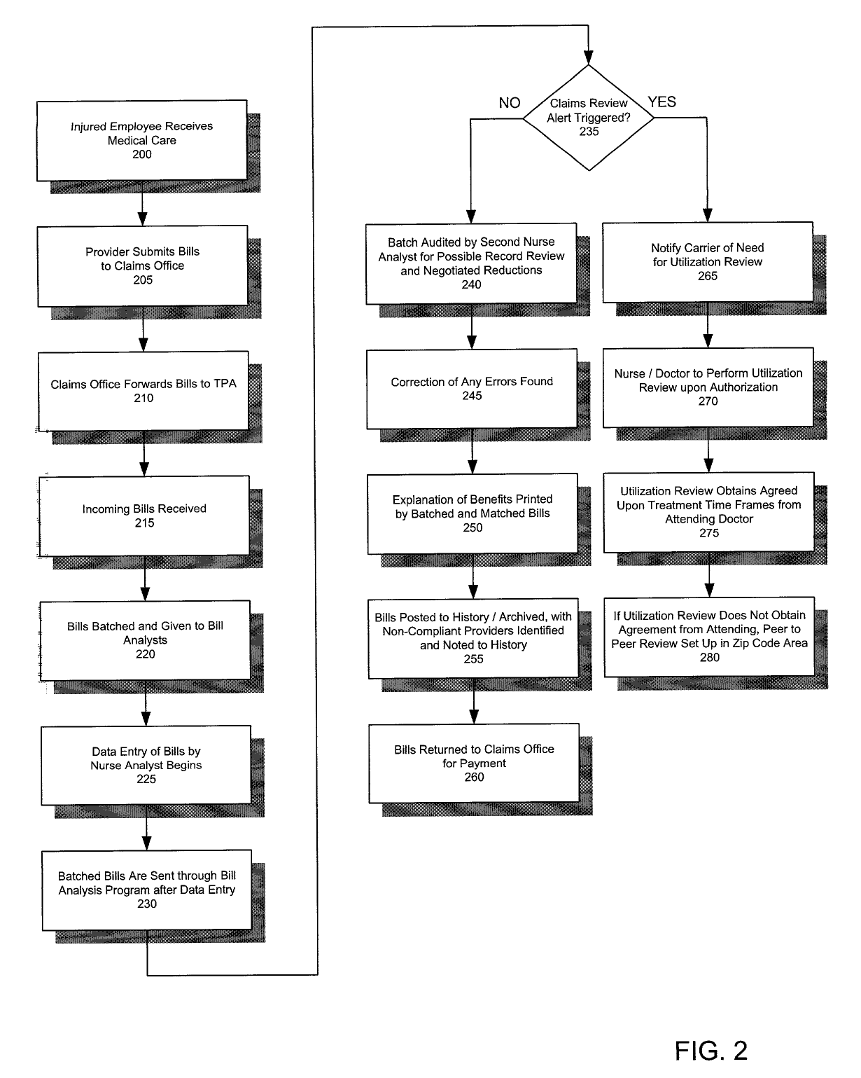

### DETAILED DESCRIPTION

### Infrastructure

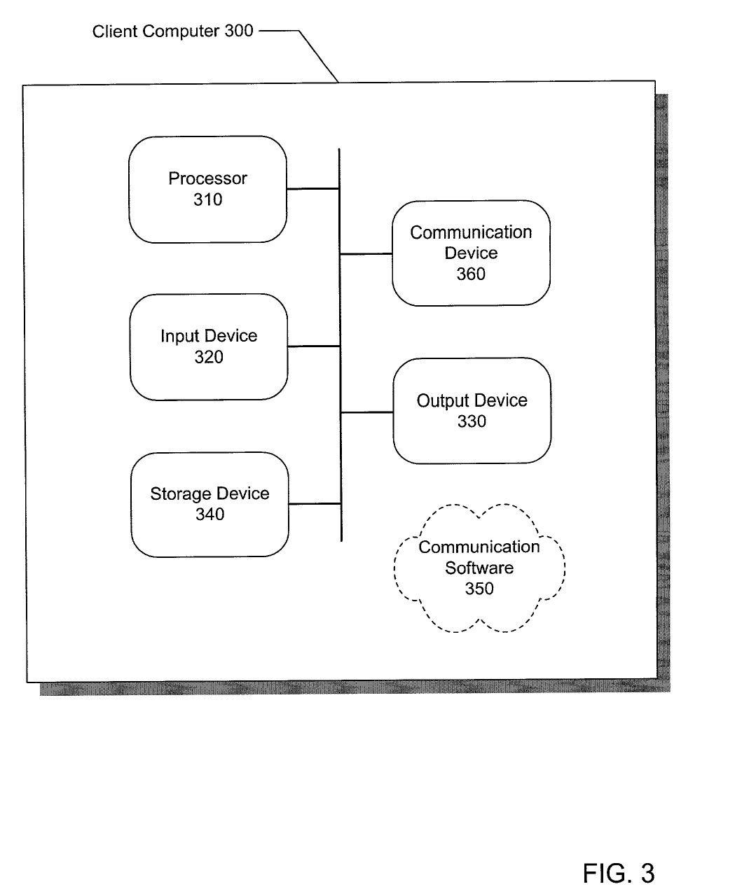

FIG. 3 is a block diagram depicting the internal structure of client computer 300 in accordance with an exemplary embodiment of the present invention. Client computer 300 may be a personal computer, “thin” client terminal, handheld personal digital assistant (“PDA”), or any other type of microprocessor-based device. Client computer 300 may include processor 310, input device 320, output device 330, storage device 340, and communication device 360. Input device 320 may include a keyboard, mouse, pen-operated touch screen, voice-recognition device, or any other device that provides input from a user. Output device 330 may include a monitor, printer, disk drive, speakers, or any other device that provides tangible output to user. Storage device 340 may include volatile data storage, such as RAM, caches, or any storage medium that temporarily holds data while it is being processed, and nonvolatile data storage, such as a hard drive, CD-ROM drive, tape drive, removable storage disk, or any other non-temporary storage medium.

Communication device 360 may include a modem, network interface card, or any other device capable of transmitting and receiving signals over a network. Communication software 350 may reside in storage device 340, and may include software to enable client computer 300 to display an application program hosted by a remote server. Communication software 350 may also include a web browser, such as Internet Explorer(TM) or Netscape(TM) Navigator(TM). One skilled in the art would appreciate that the components of client computer 300 may also be connected wirelessly, possibly through an infrared connection.

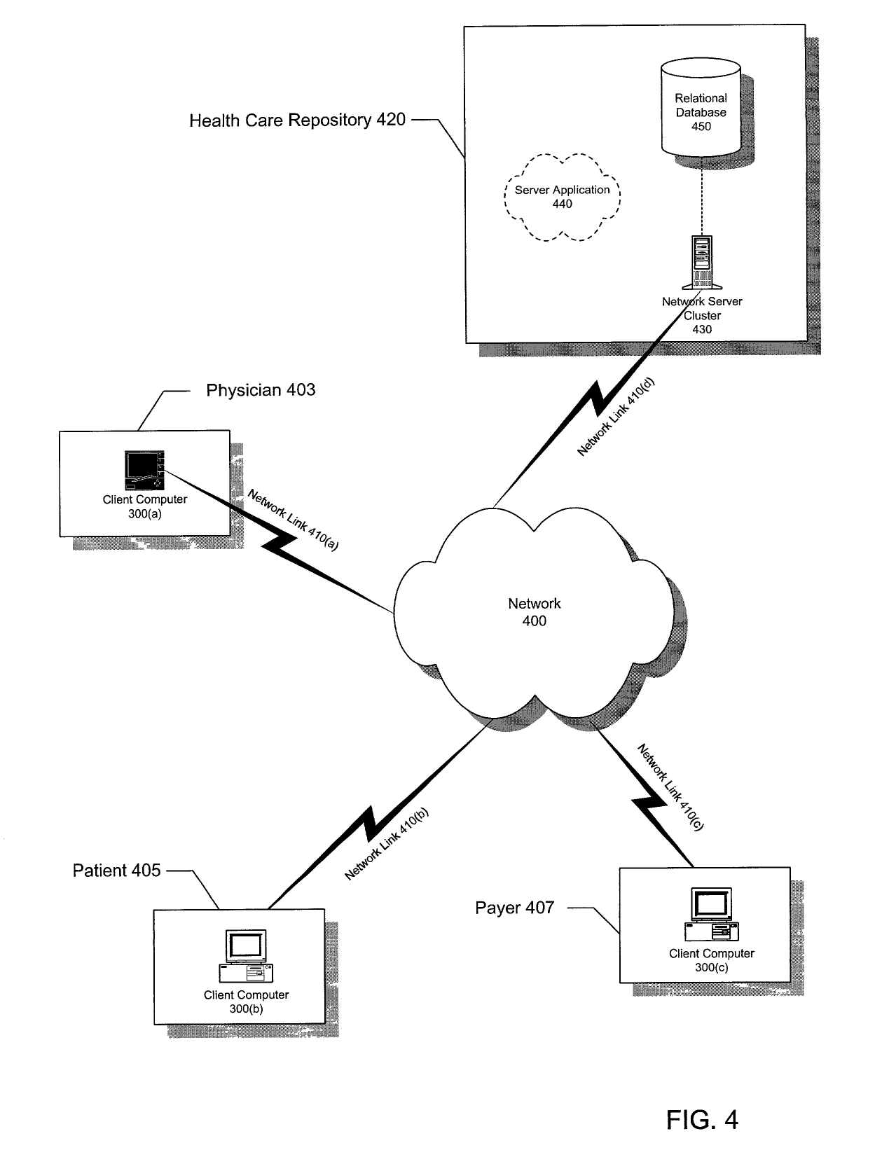

FIG. 4 is a block diagram depicting a network architecture that facilitates communication between physician 403, patient 405, payer 407 and health care repository 420 in accordance with an exemplary embodiment of the present invention. According to one embodiment, physician 403 uses communication software 350 on client computer 300(a) to communicate with health care repository 420 via network link 410(a), network 400, network link 410(d), and network server cluster 430. Network link 410 may include telephone lines, DSL, cable networks, T1 or T3 lines, wireless networks, or any other arrangement that allows for the transmission and reception of network signals. Network 400 may comprise a wide-area network (WAN), such as the Internet, a local-area network, such as an intranet, a virtual private network (VPN), etc. It should be noted that, technically, client computers 300, network links 410, network server cluster 430, and any intermediate network components, including Internet Service Providers and routers (not shown), are also part of network 400 because of their connectivity. Network 400 may implement any number of communications protocols, including TCP/IP (Transmission Control Protocol/Internet Protocol).

In an exemplary embodiment of the present invention, health care repository 420 is an application service provider that manages and distributes server application 440 to users (e.g., physician 403, patient 405, and payer 407, among others) across network 400 from network server cluster 430. Network server cluster 430 may comprise a collection of network server computers working in tandem to distribute the load of network traffic. These network server computers include processors and memory for executing program instructions as well as network interfaces (not shown). In one embodiment, network server cluster 430 may include Citrex(TM) servers, which employ a remote presentation services protocol that separates the logic of server application 440 from its user interface (i.e., it allows only keystrokes, mouse clicks and screen updates to travel over network 400 to client computers 300). Health care repository 420 also comprises, among other components, relational database 450. Users of health care repository 420 have password-protected accounts on network server cluster 430, and communication with health care repository 420 is secured by any Internet security protocol, such as Secured Sockets Layer (SSL).

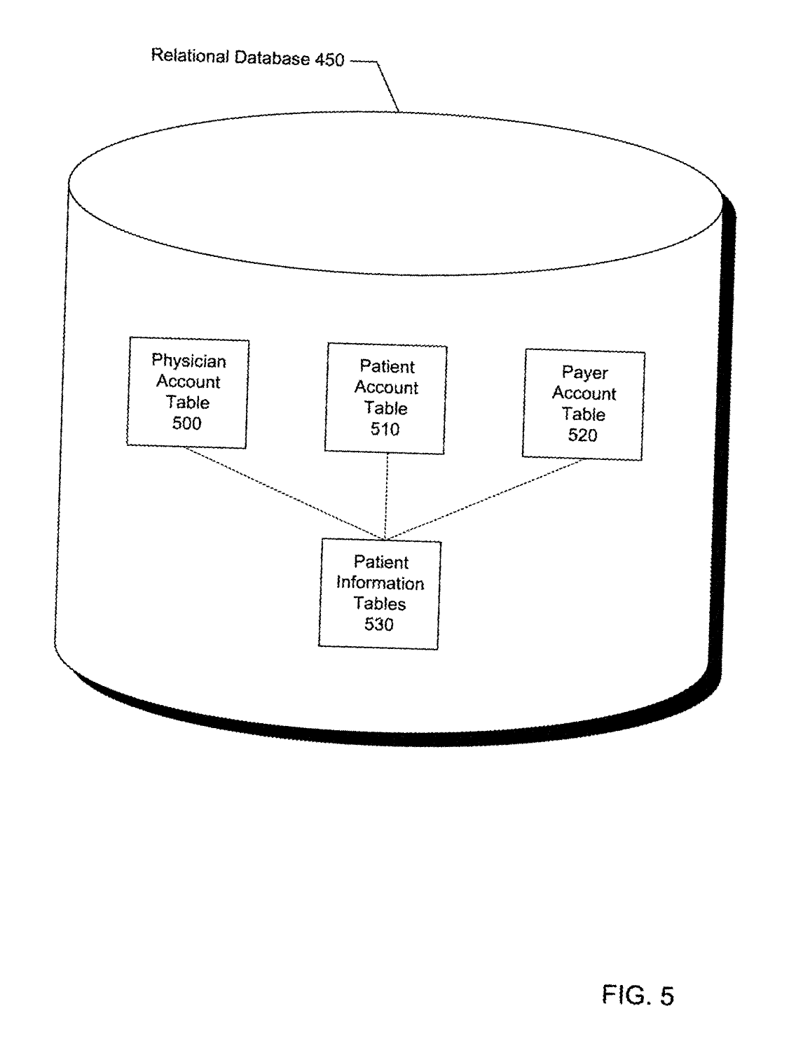

Health care repository 420 comprises relational database 450, which stores information for all users of health care repository 420. As shown in FIG. 5, relational database 450 includes physician account table 500, patient account table 510, payer account table 520, and patient information tables 530. Physician account table 500 stores, for each physician 403 belonging to health care repository 420, information such as name, hospital, and a list of associated patient's 405 names. Patient account table 510 stores for each patient 405 demographic information, such as name, age, sex, race, insurance type, etc. Payer account table 520 stores for each payer 407 information including company name and list of patients 405 who are employees, etc. Patient information tables 530 comprise a set of tables storing all medical information relating to each patient 405. This information includes physical examination information, test information (diagnostic, laboratory, etc.), patient history information, reports, etc.

### Health Care Repository

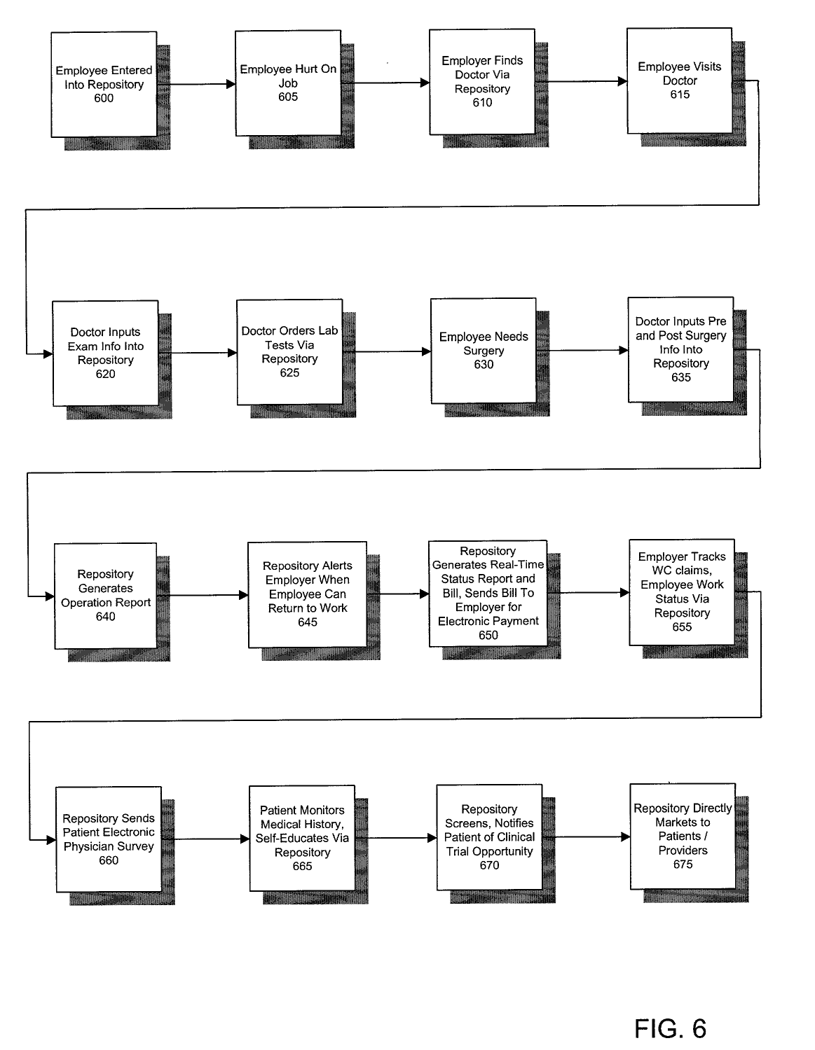

FIG. 6 is a flowchart of steps illustrating the use of health care repository 420 in accordance with an exemplary embodiment of the present invention. In one embodiment, payer 407 is a self-insured company (employer), and patient 405 is an employee of the company. As an initial step, an account is created for patient 405 in health care repository 420 before any injury occurs (step 600). Once in the system, when patient 405 gets hurt on the job (step 605), payer 407 accesses health care repository 420 via client computer 300(c) for an immediate listing of available physicians 403. Server application 440 produces this information by searching physician account table 500 in relational database 450. After payer 407 locates physician 403 (step 610), server application 440 schedules the appointment and patient 405 visits physician 403 (step 615). While physician 403 conducts an examination of patient 405, physician 403 records all patient information in real time directly into health care repository 420 via client computer 300(a) (step 620). Server application 440 stores this examination information into patient information tables 530 of relational database 450. Since diagnostic tests are needed, physician 403 orders them via health care repository 420 (step 625), and server application 440 schedules the test with a medical facility, which is also a user of health care repository 420. When the test is complete, the results are stored electronically in patient information tables 530 of relational database 450. When physician 403 reviews the test results on the system, physician 403 determines that patient 405 needs surgery (step 630). Physician 403 enters pre and post surgery information into health care repository 420 in real time, so no information is forgotten after the fact (step 635). Server application 440 compiles this information, along with information relating to the actual surgery, into a surgery report, which is stored in patient information tables 530 of relational database 450 (step 640). These detailed customized reports lower the cost of medical malpractice insurance and facility error rates.

Since all information relating to the surgery, recovery time, and follow-up visits is entered into health care repository 420, health care repository 420 uses this information to alert payer 407 in real time when patient 405 is cleared to return to work (step 645), thus expediting administrative procedures for getting patient 405 back to work and preventing unnecessary absences. Health care repository 420 generates a real-time status report on patient's 405 surgery and treatment, and sends the bill to payer 407 for electronic payment (step 650). With this information, payer 407 can not only track it's employees' worker's compensation claims, but also study where and how most employees become injured so that future injury may be prevented (step 655). Health care repository 420 eliminates most of the need for third-party administrators (TPAs), who are usually hired to adjudicate self-insured companies' claims, and who have financial incentives to lengthen the claim administration process to increase their fee.

To improve care, health care repository 420 sends patient 405 an electronic survey to answer questions relating to patient's 405 treatment and physician's 403 facility (step 660). Patient 405 monitors patient's 405 medical history by accessing health care repository 420 to study detailed reports generated from the visit. Patient 405 becomes self-educated by understanding the diagnosis and proposed treatment via research articles and links to other resources available in health care repository 420 (step 665). And due to the highly selective and accurate data stored in patient information tables 530, health care repository 420 rapidly identifies and screens with focused queries patient 420, who fits the criteria for eligibility for an upcoming clinical research study (step 670).

Additionally, with the creation of relational database 450, health care repository 420 may directly market both new and old pharmaceuticals to those patients 405 and physicians 403 who are in need of them (step 675). Health care repository 420 can generate lists of patients 405 in a particular physician's 403 practice who may benefit from various products. The direct marketing to patients 405 may take the form of fax, e-mail or conventional mail.

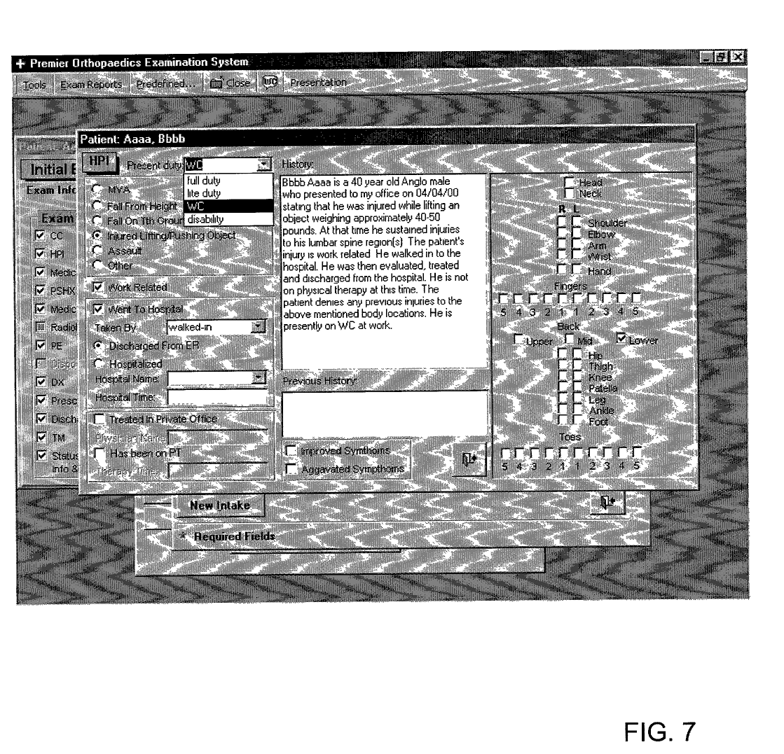

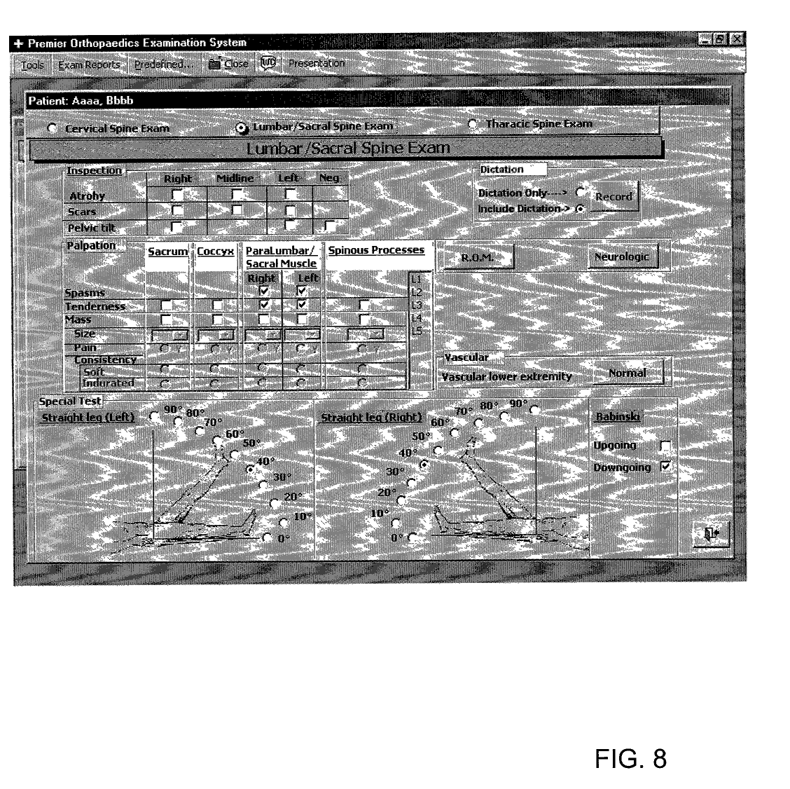

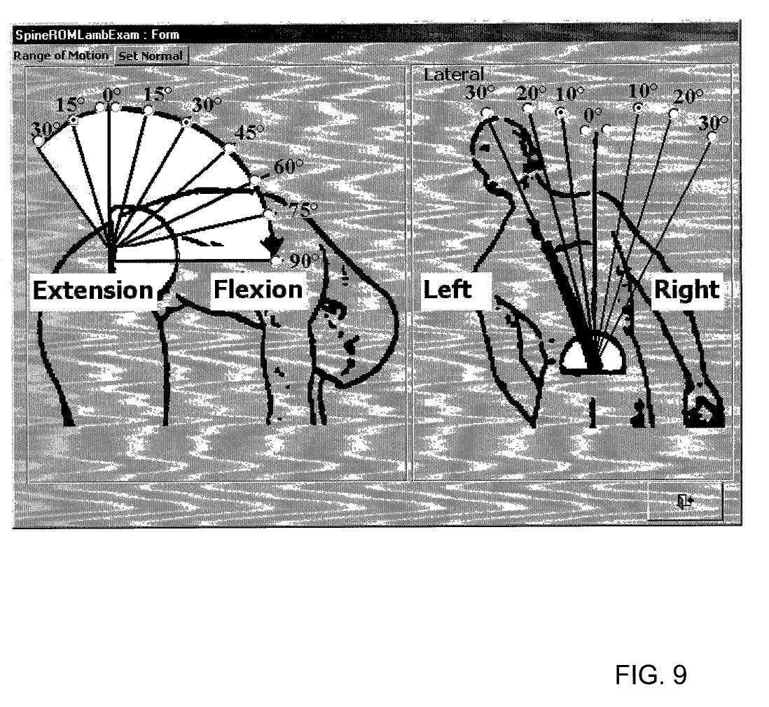

FIGS. 7-9 depict server application 440 receiving medical exam information in accordance with an exemplary embodiment of the present invention. In FIG. 7, physician 403 merely selects from the user interface the appropriate boxes of field items to log the history of patient “Bbbb Aaaa.” Server application 440 automatically compiles the selected information from the various screens into the natural language text that appears in the center area labeled “History:”. Server application 440 also has the capability of attaching physician's 403 electronically handwritten notes, audio notes, or lab results to any of server application's fields. FIG. 8 and FIG. 9 illustrate two screens that allow physician 403 to enter patient's 405 range of motion for the legs and back pictorially. This presentation format encourages physicians 403 to use server application 440 due to its ease of use.

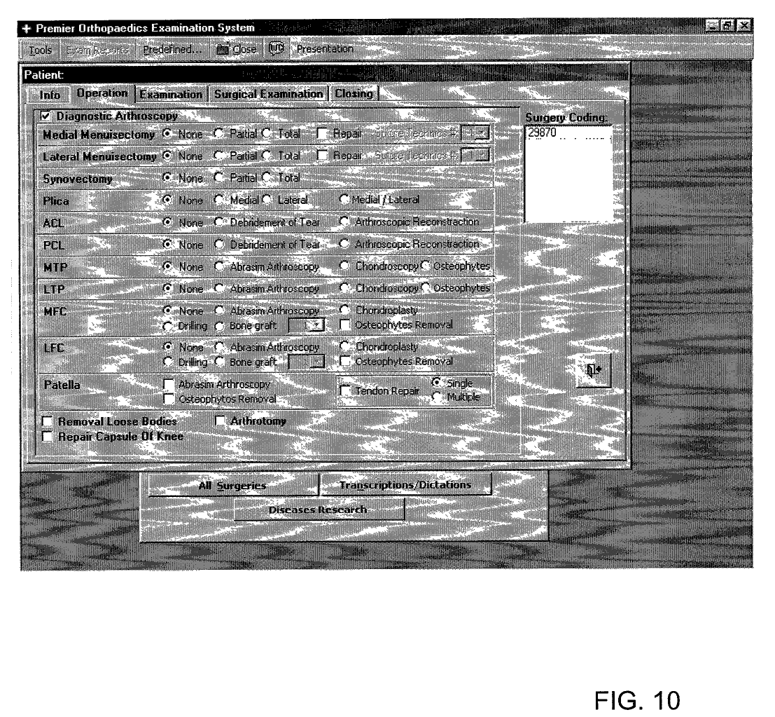

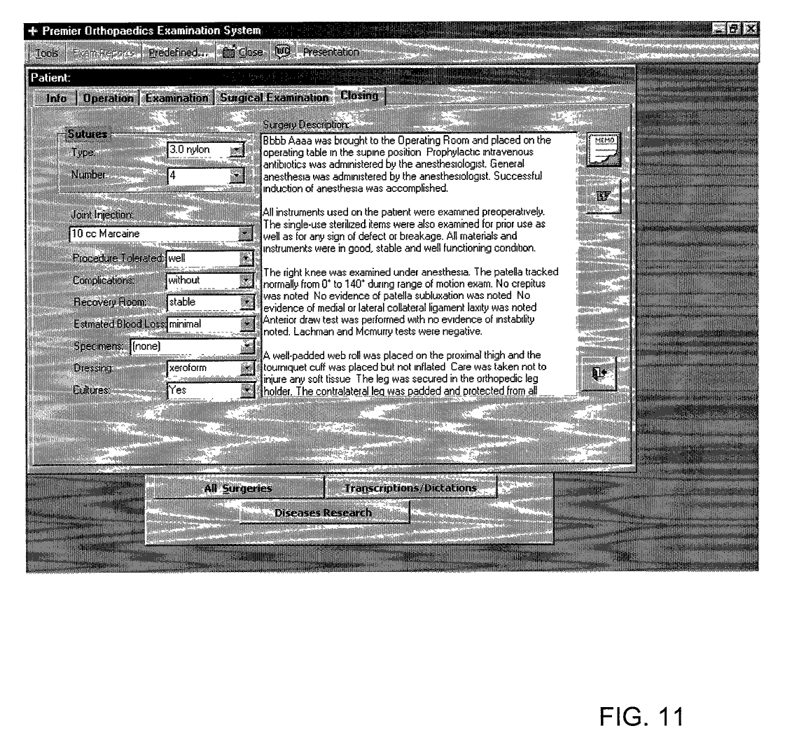

FIG. 10 and FIG. 11 depict server application 440 receiving operation information in accordance with an exemplary embodiment of the present invention. As FIG. 10 illustrates, by having physician 403 (or an assistant) select the appropriate field for every aspect of the operation listed, a complete and accurate medical record of the operation is preserved, and the operation report (including pre and post operation examination information) is automatically generated, as shown by the “Surgery Description:” field in FIG. 11.

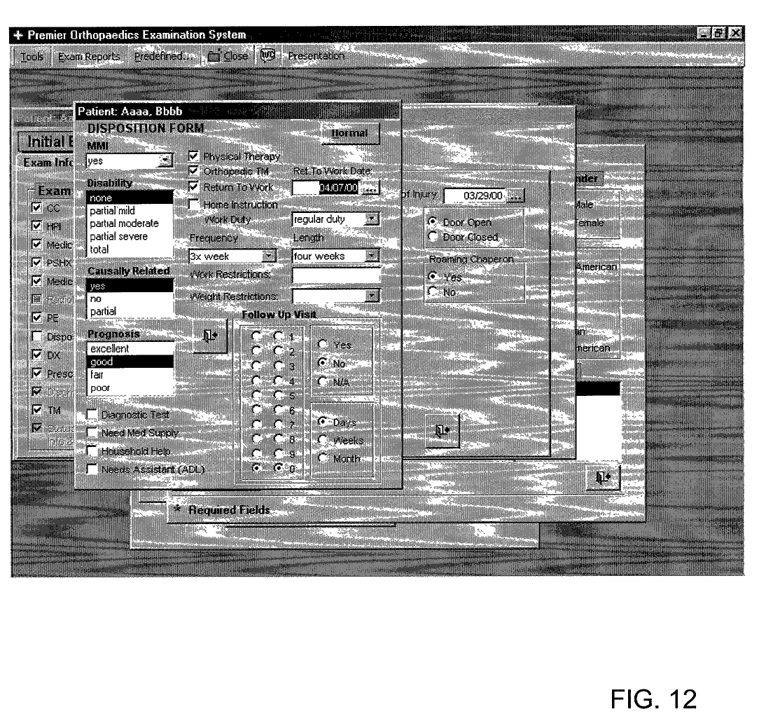

FIG. 12 depicts server application's 440 disposition form in accordance with an exemplary embodiment of the present invention. When patient 405 is ready to be discharged, physician 403 inputs patient's 405 worker's compensation disposition orders directly into server application 440.

The upper right corner of the disposition form in FIG. 12 shows that physician 403 believes that patient Bbbb Aaaa can return to work on Apr. 7, 2000. Once this information is entered, health care repository in real time alerts patient Bbbb Aaaa's employer (payer 407) of this starting date.

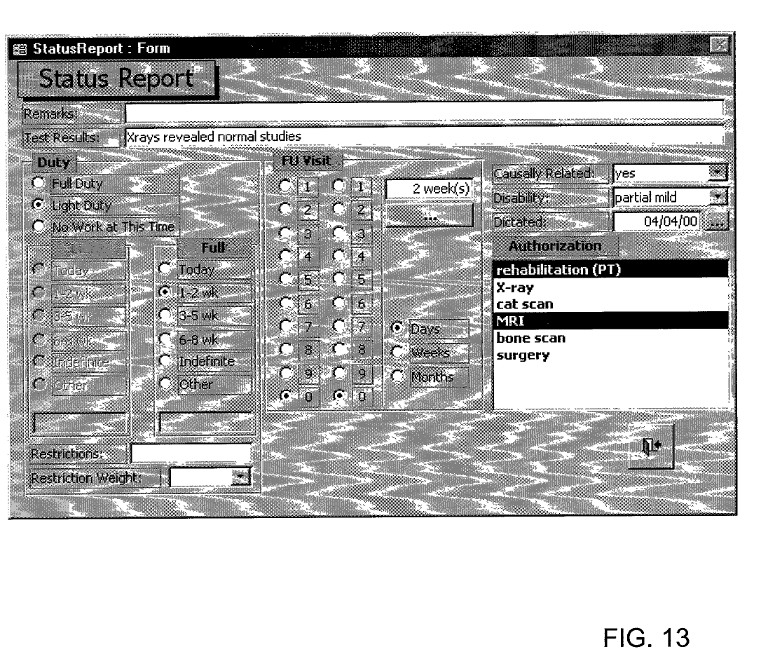

FIG. 13 depicts server application's 440 status report in accordance with an exemplary embodiment of the present invention. The status report is available for viewing from health care repository 420, and contains type of duty allowed (light), recovery period (one to two weeks), number of follow-up visits attended (none), etc. Since a major problem in the care of patients today, particularly those with chronic diseases that are often a symptomatic (high cholesterol, high blood pressure, etc), is that patients 405 stop taking their medicine or forget when their next follow-up (e.g., blood test, blood pressure check, mammogram) is scheduled, health care repository 420 provides automated reminders at pre-determined intervals via e-mail, fax, or conventional mail to patients 405. FIG. 13 illustrates a reminder interval of two weeks. This will be particularly effective in the high-risk patient 405 who has just been discharged from the hospital. These reminders may have significant financial implications for the pharmaceutical industry, the health care industry and the government if this method improves patient compliance with medications (currently approximately 50% of patients self-discontinue their medications within 12 months of therapy).

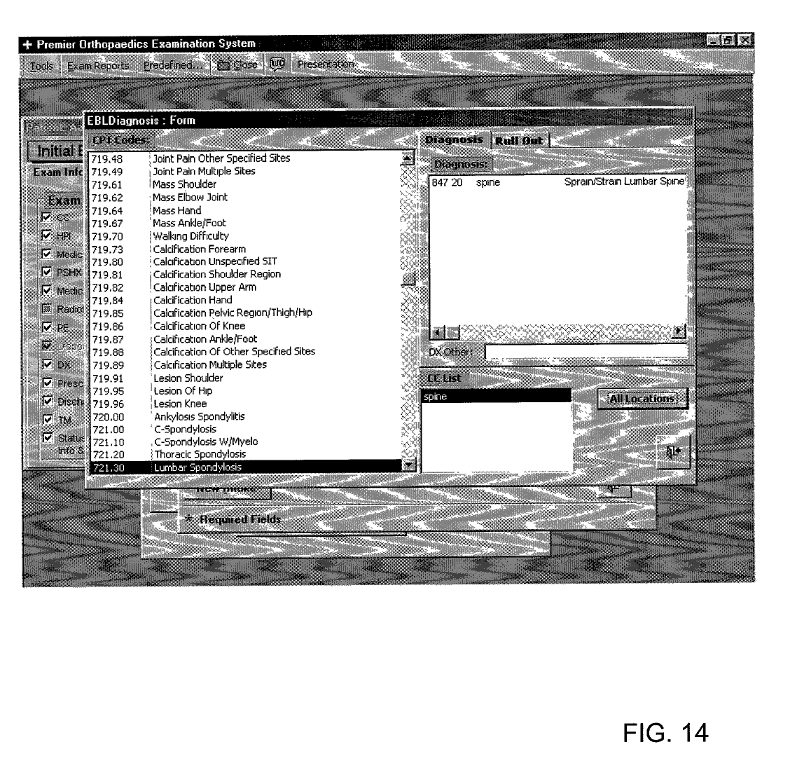

FIG. 14 depicts server application 440 compiling insurance codes for a bill in accordance with an exemplary embodiment of the present invention. Server application 440 automatically matches the patient information entered by physician 440 to the corresponding health insurance code. In one embodiment, server application 440 selects for billing purposes code 847.20, which represents sprain/strain of lumbar spine. If more than one set of insurance codes could be matched to the patient information, server application 440 selects the insurance codes corresponding to the lowest cost.

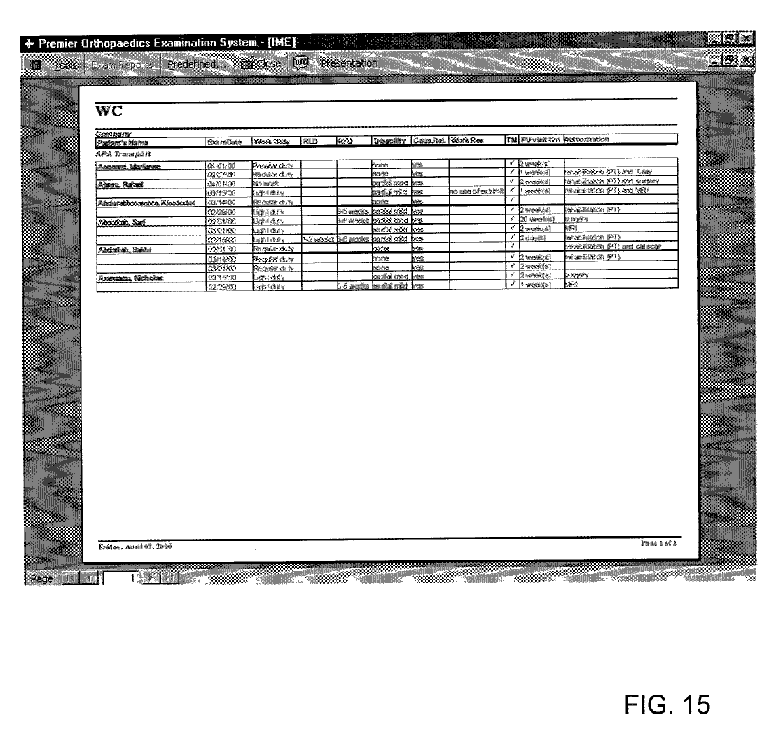

FIG. 15 depicts server application 440 generated worker's compensation report in accordance with an exemplary embodiment of the present invention. With this information readily available to payer 407 from health care repository 420, payer 407 can more efficiently monitor and organize the employees afflicted with worker's compensation injuries.

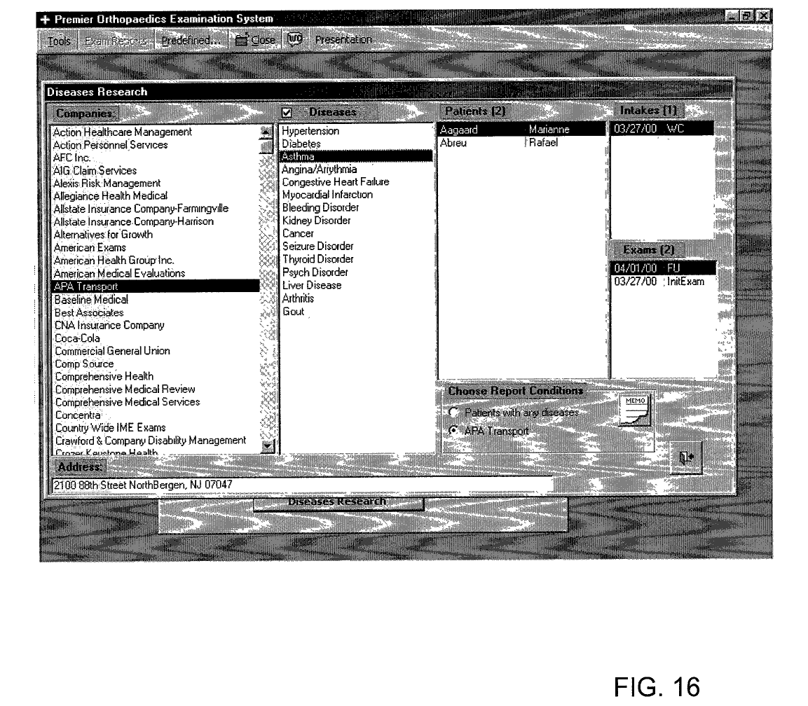

FIG. 16 depicts server application's 440 screening ability in accordance with an exemplary embodiment of the present invention. At the click of a button, all the information stored in relational database 450 may be utilized for research or other purposes (e.g., rapid identification of patients for clinical trials by pharmaceutical companies, rapid identification of patients 405 by referral centers and weight loss rehabilitation centers, direct marketing to patients 405 and/or physicians 403, direct patient and physician educational content, quality assurance for physicians 403, insurers, hospitals, employers (identifying quality health plans and providers), etc.).

According to an exemplary embodiment of the present invention, server application 440 examines health care practitioners' adherence to national guidelines in prevention of disease, while also providing real time feedback. Some of the recognized governing bodies are:

American Heart Association (AHA)

American College of Cardiology (ACC)

American College of Chest Physicians (ACCP)

National Cholesterol Education Program (NCEP)

Agency for Health Care Policy and Research/Agency for Healthcare Research and Quality (AHCPR/AHRQ)

Joint National Committee on Detection, Evaluation, and Treatment of High Blood Pressure (JNC VI)

The following is a list of disease entities and treatment strategies, or goals, that may be targeted in the present invention:

achievement of NCEP LDL goals and the usage of statins in patients with hyperlipidemia

usage of aspirin in patients with coronary artery disease (ACC/AHA)

usage of P-blockers in patients after myocardial infarction (ACC/AHA)

usage of ACE inhibitors in patients with systolic left ventricular dysfunction (ACC/AHA)

usage of warfarin or aspirin in patients with chronic atrial fibrillation (ACCP)

a achievement of normal blood pressure goals (JNC VI)

Recommendations from these guidelines are designated as compelling, “Class I” or “Grade A”, less compelling, “Class II” or “Grade B”, or contraindicated, “Class III” or “Grade C”. A Class I recommendation implies that convincing evidence supports the use of that particular treatment strategy which should be implemented in all patients unless contraindicated. Class II recommendations are encouraged but not mandated. In one embodiment, server application 440 utilizes class I or grade A recommendations to measure adherence to the treatment guidelines, and bases the need for specific goals on the presence or absence of a disease. Server application 440 also provides quality assurance by identifying accepted medical reasons why patient 405 is not in compliance with the guidelines.

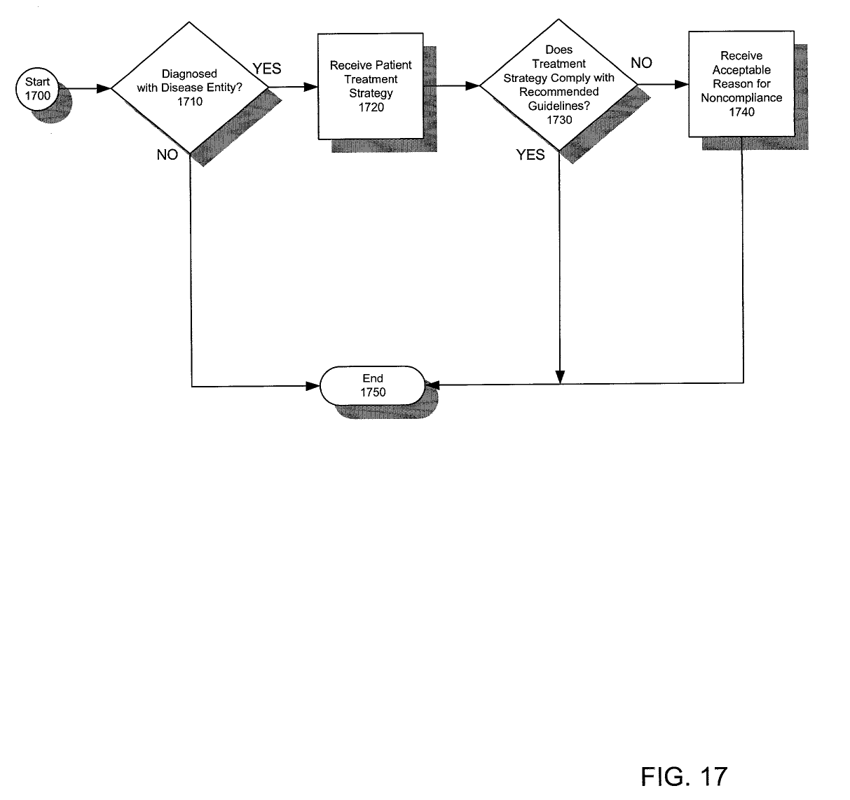

FIG. 17 is a flowchart of steps illustrating the logic of server application 440 in accordance with an exemplary embodiment of the present invention. In one embodiment, server application 440 queries a health care practitioner (e.g., physician 403, or any program user) whether patient 405 has been or is being diagnosed with a certain disease (step 1710). If so, server application 440 receives the treatment strategy from the practitioner (step 1720). If the treatment strategy is in compliance with recommended guidelines for that particular disease, the process ends (step 1730). If not, server application 440 requires the practitioner to enter a reason why the current treatment strategy does not comply with existing guidelines (step 1740). The range of acceptable reasons for noncompliance may also derive from existing guidelines and recognized literature.

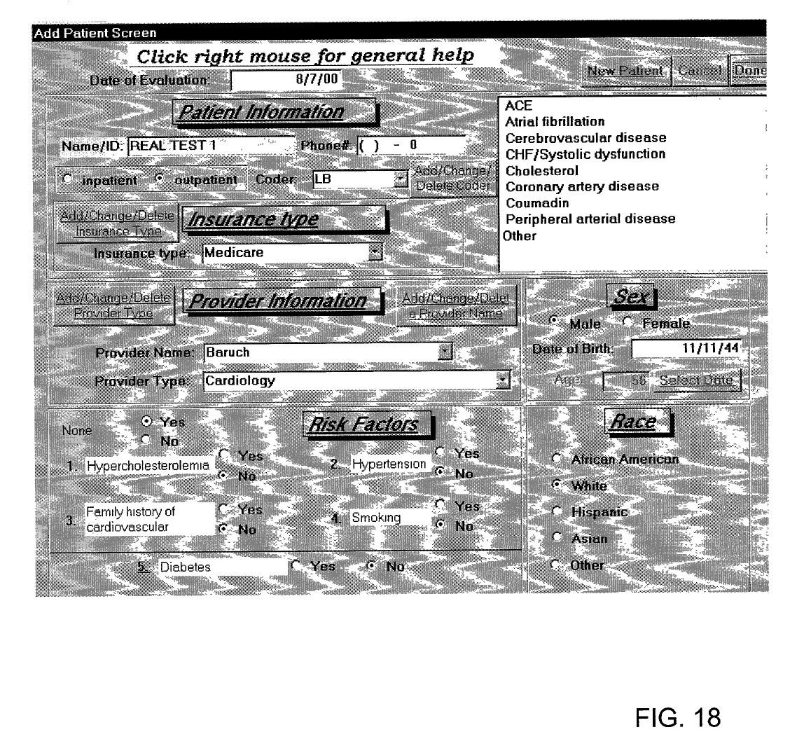

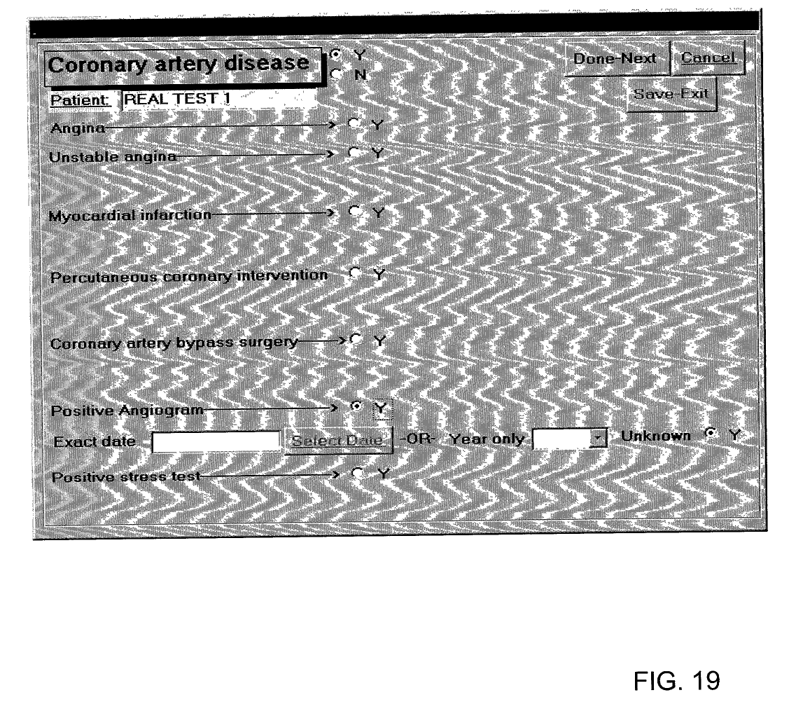

FIGS. 18-32 illustrate how server application 440 examines health care practitioners' adherence to the recommended guidelines. In particular, FIGS. 18-27 illustrate one scenario in which the practitioner is examining a patient by the name of “REAL TEST 1.” FIG. 18 depicts an introductory screen in which a health care practitioner may enter patient, insurance, and provider information. In FIG. 19, the practitioner entered the fact that patient 405 has coronary artery disease (as shown by the “Y” selected after the “Coronary artery disease” caption). In response to server application's 440 prompt for how the diagnosis of coronary artery disease was determined (as shown by remainder of fields in FIG. 19), the practitioner has indicated a positive angiogram.

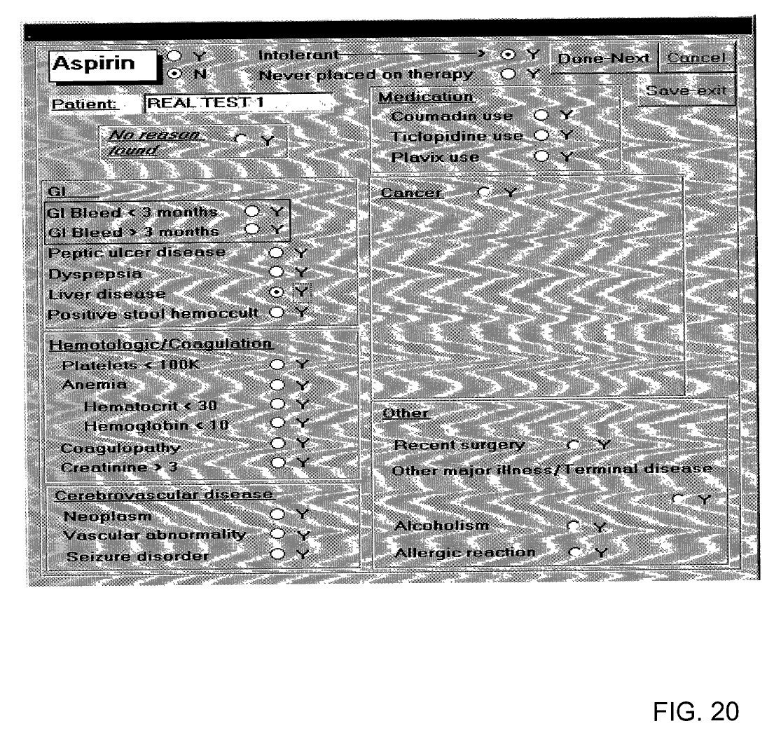

Since the practitioner entered “yes” for the existence of coronary artery disease, server application 440 in FIG. 20 prompts the practitioner to answer if patient 405 is receiving aspirin or not (as per the guidelines). Since the practitioner has indicated “no” in response to the prompt (as shown by the “N” selected after the “Aspirin” caption), server application 440 queries the practitioner as to why patient 405 is not on aspirin (as shown by the remainder of fields in FIG. 20, which appear after the practitioner clicks on the “NO” next to the “Aspirin” caption). The practitioner has indicated that patient 405 is intolerant of aspirin due to liver disease, which is an accepted reason for noncompliance with the guidelines. (If no accepted reason is discovered, the practitioner may select the “No reason found” field).

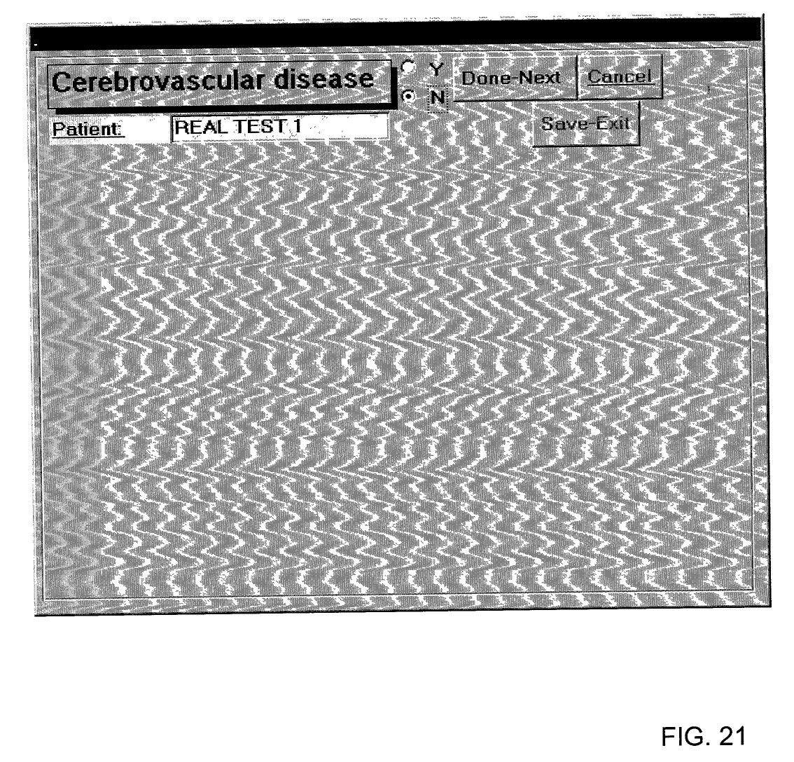

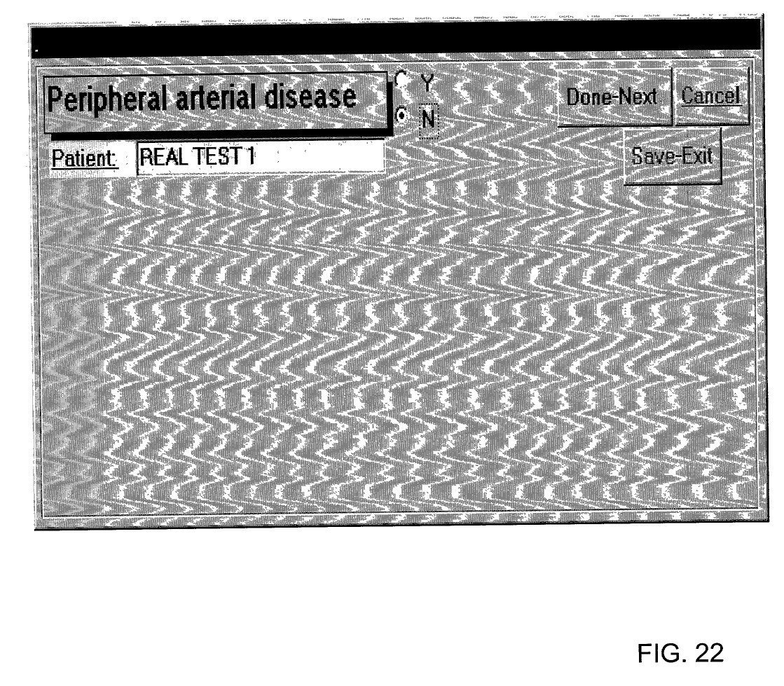

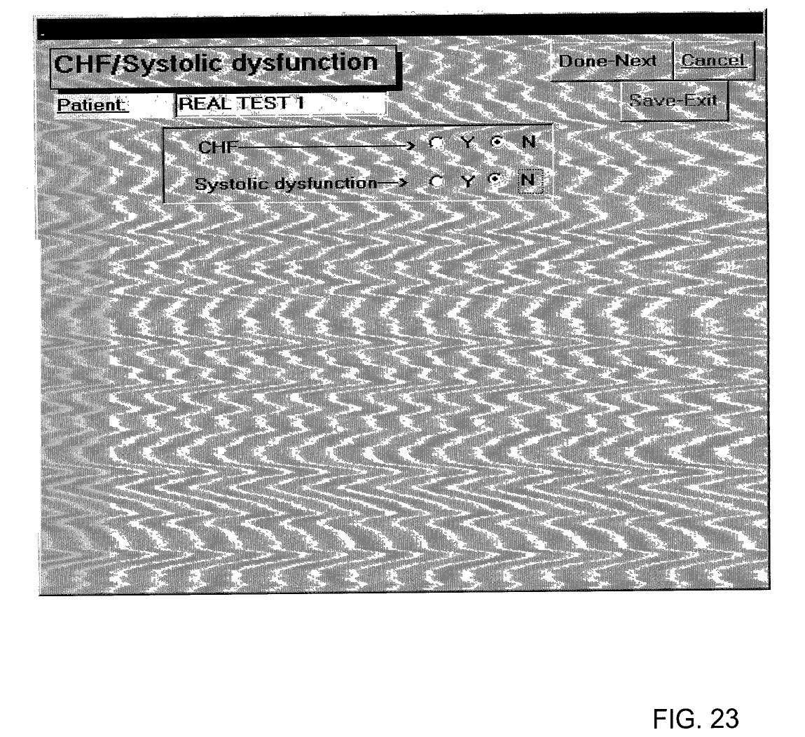

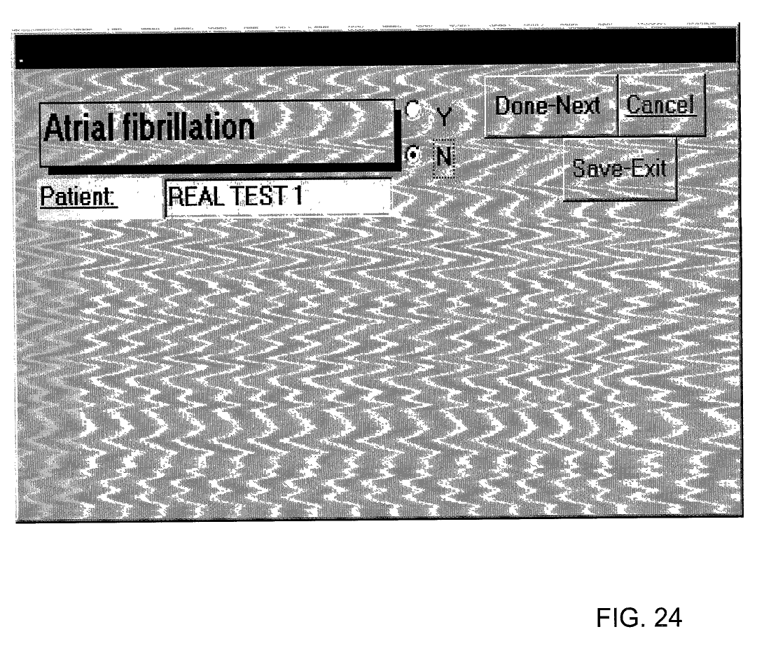

Because the presence or absence of cerebrovascular disease may influence the cholesterol goal number (derived from accepted guidelines), server application 440 prompts the practitioner to answer if patient 405 has cerebrovascular disease (FIG. 21). After the practitioner indicates “no” in this scenario, server application 440 prompts whether patient 405 has peripheral arterial disease (FIG. 22), because the presence or absence of peripheral arterial disease may influence the cholesterol goal number. After the practitioner responds “no,” server application 440 prompts whether patient 405 has congestive heart failure (CHF) and systolic dysfunction (FIG. 23), because the presence or absence of congestive heart failure influences the use of certain medications. The practitioner answers “no” to this prompt and to the subsequent prompt regarding the existence of atrial fibrillation (FIG. 24).

Note that the presence or absence of cerebrovascular disease or peripheral arterial disease influences the cholesterol goal only in the absence of coronary artery disease; patient REAL TEST 1 in the current embodiment has coronary artery disease.

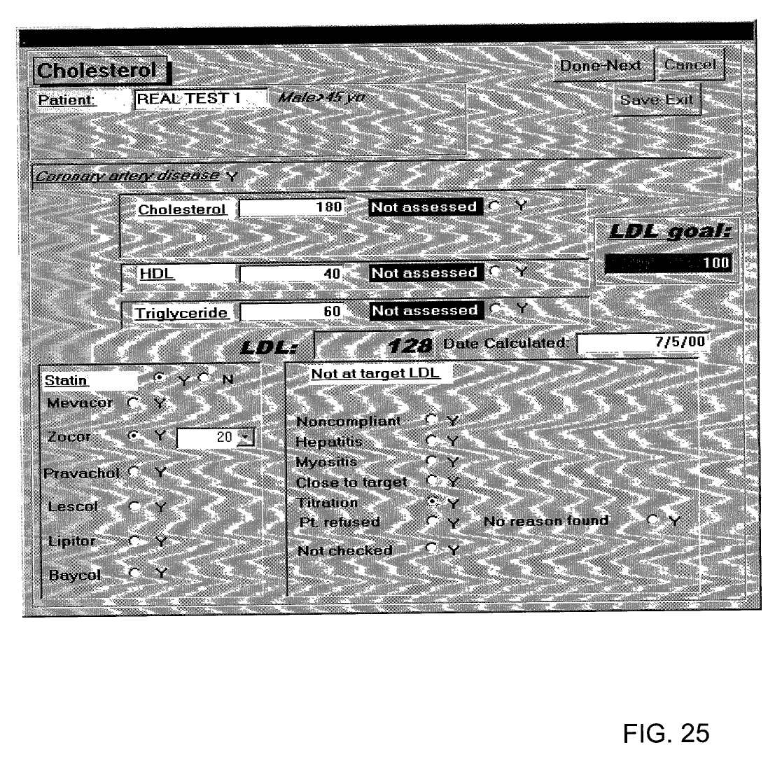

Server application 440 then prompts the practitioner to enter patient's 405 lipid profile in FIG. 25. The practitioner enters “180” for cholesterol, “40” for HDL, and “60” for Triglyceride, as shown under the heading “Coronary artery disease.” Based on an algorithm derived from NCEP ATP II guidelines, server application 440 determines if patient 405 is at the target LDL goal of 100 for coronary artery disease. Since the calculated LDL value is 128 (as shown in FIG. 25), server application 440 queries the practitioner why patient 405 is not at the target LDL. As shown in the bottom right portion of the screen in FIG. 25, practitioner indicates titration to be the reason for noncompliance with the NCEP ATP II guidelines.

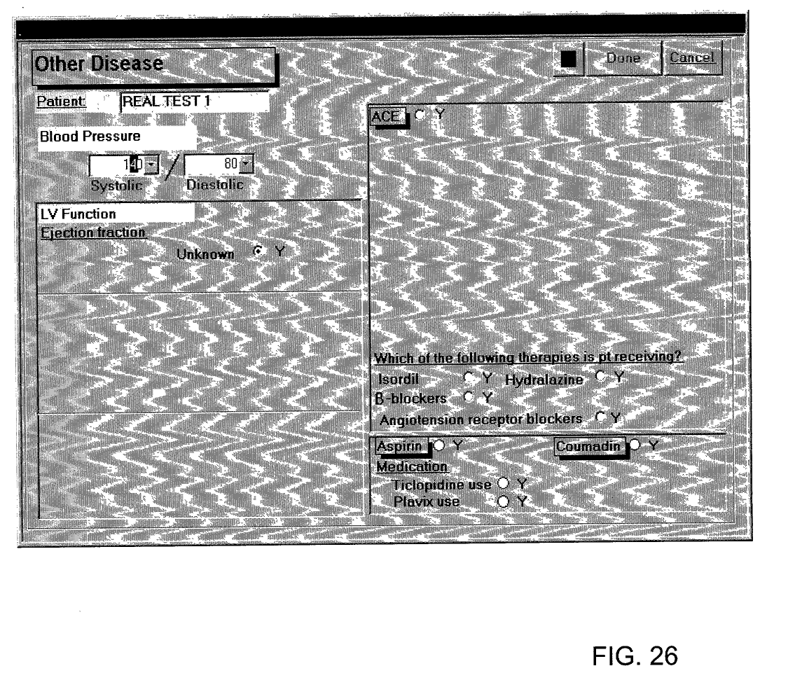

Server application 440 through the screen in FIG. 26 captures various important pieces of information that relate directly to guidelines as well as cardiovascular disease in general. At the top left of the screen in FIG. 26, server application 440 prompts the practitioner to enter patient's 405 blood pressure to assess whether patient 405 is at the goal blood pressure for that patient. Throughout the remainder of the screen, server application 440 collects key cardiovascular disease information that is important to both the practicing clinician as well as the prevention and treatment of cardiovascular disease but has yet to be included into accepted guidelines, althoiugh it may be included in the near future. Because of logistical reasons, despite new and unequivocal data, guidelines are not updated every day or every year (on average they are updated every 3-5 years). Thus identification of key patient data and integration with new research allows for the rapid incorporation of future guideline goals in real time (as the new information is released in publications, press releases, at medical meetings, etc.).

For example, a recent study (published by HOPE) demonstrated the benefit of ACE inhibitors in patients with vascular disease without a diagnosis of heart failure. The screen in FIG. 26 allows practitioners to identify whether a patient is or is not receiving an ACE inhibitor. Thus both patient 405 and physician 403 can be informed of the latest clinical trial results and decide whether the patient should or should not be receiving an ACE inhibitor. This will occur prior to any inclusion in any guidelines because the research is too recent to have been incorporated into any guidelines. Presently the same issues exist with β-blockers in congestive heart failure. Over and above this, a number of research studies are ongoing to assess the role of angiotension receptor blockers in patients with heart failure. Health care repository 420 captures this important information now, even if the relevant research is ongoing or the guidelines have not been changed yet.

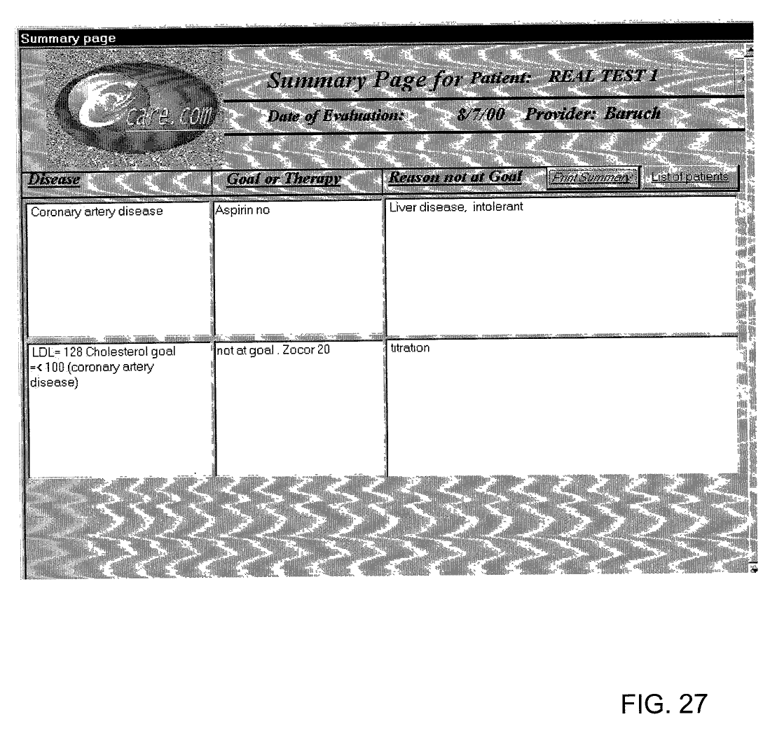

Server application 440 integrates all entered information and generates a summary report for patient REAL TEST 1, as illustrated in FIG. 27. The patient 405 and physician 403 have this information immediately available which serves as an educational tool as to what the patientspecific (not generic) goals are, as well as a reminder system for both patients 405 and physicians 403 to achieve these goals.

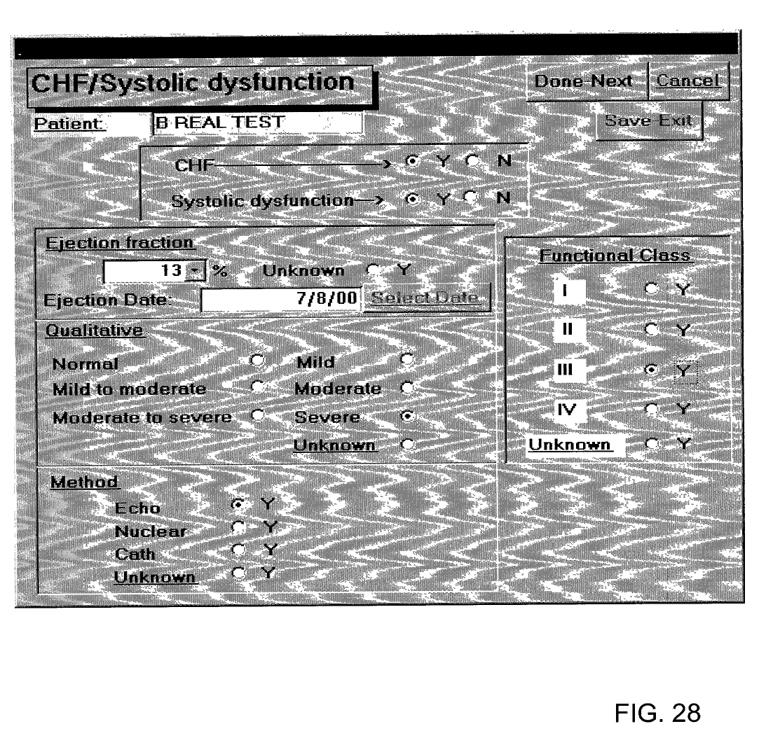

FIGS. 28-31 illustrate a scenario in which the practitioner examines a patient named “B REAL TEST,” who is similar to patient “REAL TEST 1” except with congestive heart failure.

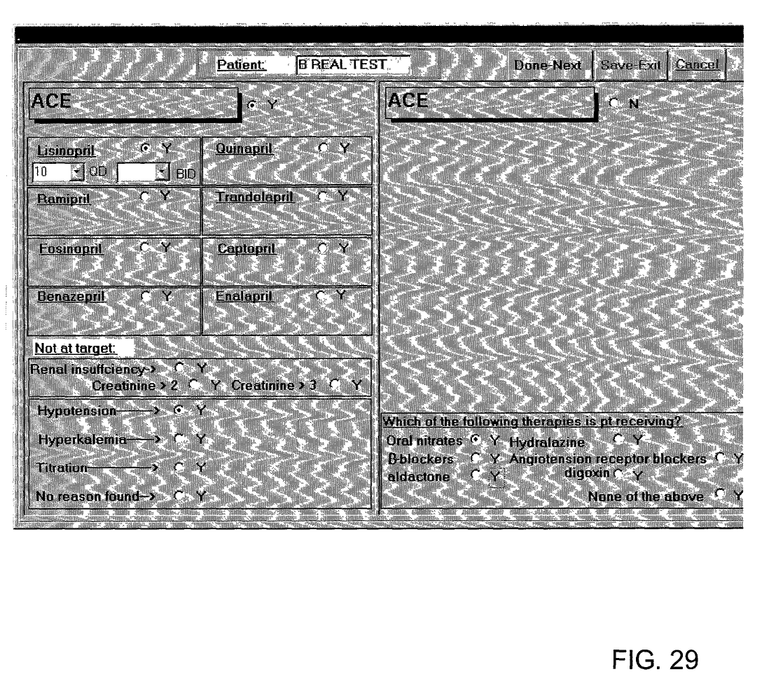

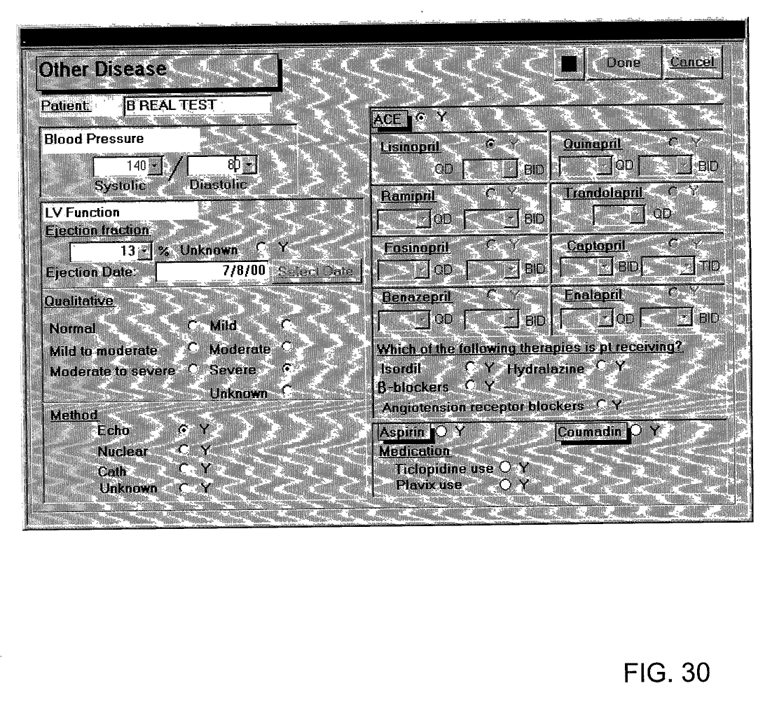

The information reflected in FIGS. 18-22 remains the same (except for the name), but when server application 440 queries the practitioner on the existence of CHF and systolic dysfunction, the practitioner responds in the affirmative (FIG. 28). In response to this, server application 440 presents fields in FIG. 28 allowing the practitioner to document information on patient's 405 condition (e.g., ejection fraction of 13%, severe, etc.). Because of the existence of CHF, server application 440 next queries the practitioner whether patient 405 was placed on an ACE inhibitor (FIG. 29), which is a medication for the treatment of CHF. Since practitioner responded positively, the practitioner is prompted to input information about the usage of this treatment strategy (as shown in middle left fields in FIG. 29). Because the practitioner entered a dosage of 10 mg for the Lisinopril field, and because that dosage in inadequate as determined from ACC, AHA, and AHCPR guidelines, server application 440 accordingly prompts the practitioner to indicate why patient's 405 treatment strategy is inadequate (as shown at the bottom left of the screen in FIG. 29). The practitioner indicates that hypotension is the cause for the lower dosages of Lisinopril. Server application 440 displays in FIG. 30 the captured key cardiovascular information, and prompts the practitioner for other therapies received by patient 405.

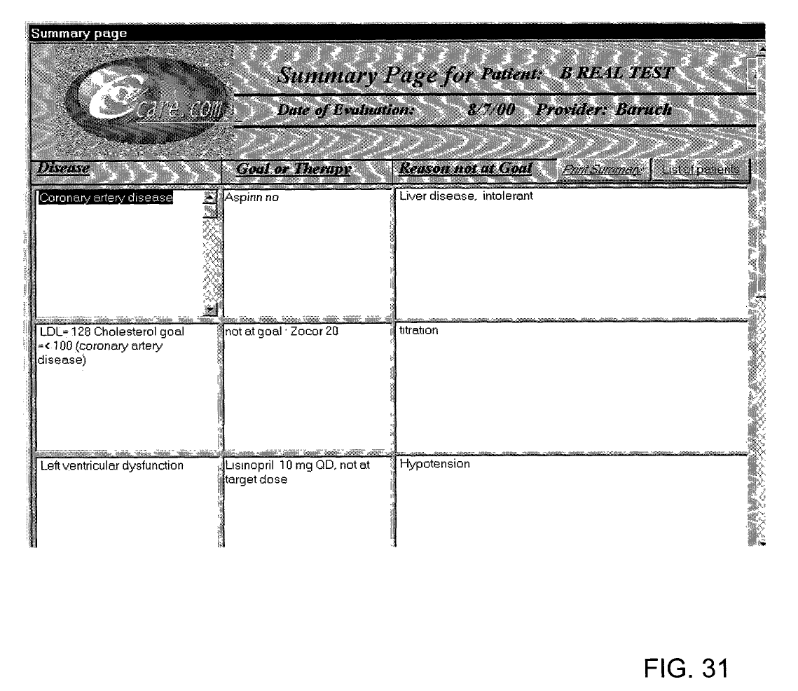

Server application 440 integrates all entered information and generates a summary report for patient B REAL TEST, as illustrated in FIG. 31. Upon comparing FIG. 31 with FIG. 27, one can see the additional disease category and analysis for left ventricular (LV) dysfunction.

Another aspect of the present invention is that server application 440 integrates information from one area (e.g., disease entity, treatment strategy) to another. For instance, the following logic in server application 440 is utilized to determine stroke risk in a patient with atrial fibrillation:

If cerebrovascular accident yes or transient ischemic attack yes or LV dysfunction moderate or moderate to severe or severe yes or ejection fraction <40% or CHF yes or hypertension yes or age >75 then high

If cerebrovascular accident no and transient ischemic attack no and hypertension no and either age >65 <75 or diabetes yes or coronary artery disease yes or LV function mild to moderate or ejection fraction >40 <45 yes then moderate

If cerebrovascular accident no and transient ischemic attack no and LV function normal or mild and CHF no and hypertension no and diabetes no and age <65 then low

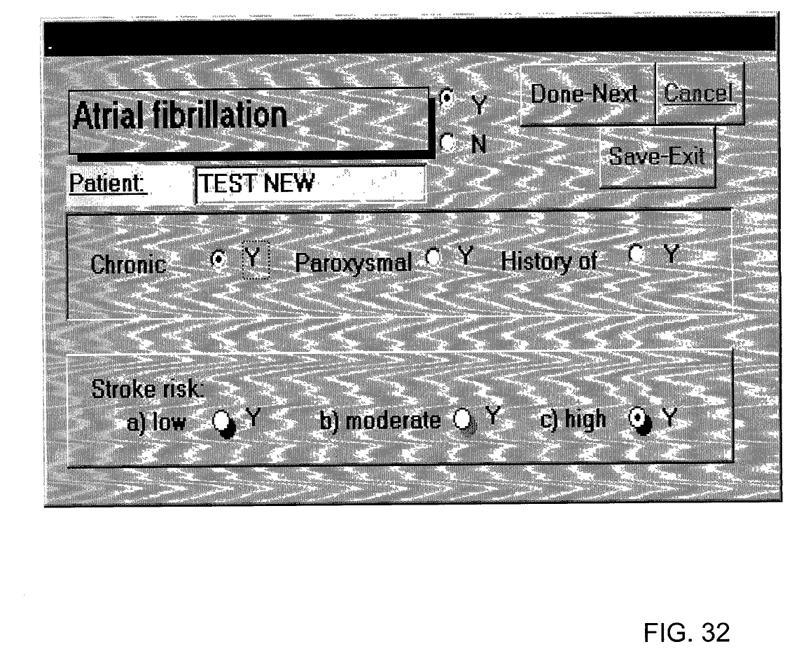

The screen in FIG. 32 illustrates the integration of information from different disease entities in the stroke risk context in accordance with an exemplary embodiment of the present invention. After the practitioner entered “yes” for atrial fibrillation, the remaining fields dropped down for documenting information on patient TEST NEW's atrial fibrillation. The stroke risk field of the screen in FIG. 32 is not filled by the practitioner, but is automatically filled based on information previously entered from prior fields, such as CHF “yes” or prior cerebrovascular accident “yes” for high risk of stroke. This logic illustrates how server application 440 connects one disease entity, such as heart failure, with another disease entity, such as atrial fibrillation. The stroke risk logic is driven by algorithms from medical literature and accepted guidelines.

An additional feature of the present invention is the ability to interface with other programs to automatically load information directly into health care repository 420. For example, ejection fraction and left ventricular function are two fields shown on the screen in FIG. 30. This information is derived from an echocardiogram, nuclear ventriculogram or a cardiac catheterization. Instead of having physician 403 enter the data manually, server application 440 may automatically and seamlessly load the appropriate information from other programs that collect the data from the echocardiogram, etc. Thus the other programs connect into health care repository 420, which functions as a filter to take in information and process it according to the findings of the other programs (i.e. echocardiogram, cardiac catheterization, etc.) and then generate reminders, etc.

The data that the other programs provide for health care repository 420 is not limited to medical test data. In an alternative embodiment, the data may relate to fitness information that could be generated in association with patient's 405 physical therapy schedule or general exercise regimen. A fitness facility, via computerized exercise machines or manual data entry, may generate such data for patient 405 while patient 405 is working out. This fitness information may then be transferred to patient's 405 client computer 300(b), which would route the appropriate information to health care repository 420. In this manner, patients 405 can learn and be reminded what their goals are outside of physician's 403 office.

Several embodiments of the present invention are specifically illustrated and/or described herein. However, it will be appreciated that modifications and variations of the present invention are covered by the above teachings and within the purview of the appended claims without departing from the spirit and intended scope of the present invention.

What is claimed is:

1. A method for facilitating treatment of a patient by a health care provider, comprising the steps of:
(a) providing a first user interface to the health care provider;
(b) providing a second user interface to the patient;
(c) receiving information associated with the patient via the first user interface in response to a medical visit with the health care provider;
(d) providing a treatment goal specific to the patient via the second user interface based upon the received information.

2. The method according to claim 1, further comprising the steps of:
(e) providing a third user interface to a representative of a self-insured company, the patient being an employee of the self-insured company;
(f) providing data associated with the received information to the representative of the self-insured company in real time via the third interface.

3. The method according to claim 1, wherein the received information includes at least one of an examination description and a history description.

4. The method according to claim 1, further comprising the step of:
(e) generating at least one of an operation report, a status report, and a worker's compensation report.

5. The method according to claim 1, further comprising the step of:
(e) directly marketing medical products to at least one of the health care provider and the patient based on the received information.

6. The method according to claim 1, further comprising the step of:
(e) providing educational content to the patient via the second user interface.

7. The method according to claim 1, further comprising the step of:
(e) providing medication reminders to the patient via the second user interface.

8. A method for managing clinical practice for a health care practitioner, comprising the steps of:
(a) electronically receiving an indication of a disease entity associated with a patient; and
(b) displaying at least one treatment strategy associated with the disease entity in compliance with guidelines recommended by recognized governing bodies.

9. The method according to claim 8, further comprising the steps of:
(c) electronically receiving the treatment strategy utilized by the patient;
(d) displaying whether the treatment strategy utilized by the patient achieves a corresponding treatment goal in compliance with the guidelines.

10. The method according to claim 9, further comprising the step of:
(e) if the treatment strategy utilized by the patient does not achieve the corresponding treatment goal, displaying at least one reason in compliance with the guidelines as to why the patient is not achieving the goal.

11. The method according to claim 8, further comprising the step of:
(c) displaying at least one assessment associated with one disease entity based on prior entered information associate d with another disease entity.

12. The method according to claim 8, further comprising the step of:
(c) receiving information associated with the patient, the information including at least one of a result from an echocardiogram, a result from a nuclear ventriculogram, a result from a cardiac catheterization, and a fitness data.

13. A system for facilitating treatment of a patient by a health care provider, comprising:
a communication device; and
a processor providing a first user interface to the health care provider via the communication device, the processor providing a second user interface to the patient via the communication device, the processor receiving information associated with the patient via the first user interface in response to a medical visit with the health care provider, the processor providing a treatment goal specific to the patient via the second user interface based upon the received information.

14. The system according to claim 13,
wherein the processor provides a third user interface to a representative of a self-insured company, the patient being an employee of the self-insured company, and
wherein the processor provides data associated with the received information to the representative of the self-insured company in real time via the third interface.

15. The system according to claim 13, wherein the received information includes at least one of an examination description and a history description.

16. The system according to claim 13, wherein the processor generates at least one of an operation report, a status report, and a worker's compensation report.

17. The system according to claim 13, wherein the processor directly markets medical products to at least one of the health care provider and the patient based on the received information.

18. The system according to claim 13, wherein the processor provides educational content to the patient via the second user interface.

19. The system according to claim 13, wherein the processor provides medication reminders to the patient via the second user interface.

20. A system for managing clinical practice for a health care practitioner, comprising:
an input device;
an output device; and
a processor receiving, via the input device, an indication of a disease entity associated with a patient, the processor displaying via the output device at least one treatment strategy associated with the disease entity in compliance with guidelines recommended by recognized governing bodies.

21. The system according to claim 20,
wherein the processor receives the treatment strategy utilized by the patient, and
wherein the processor displays whether the treatment strategy utilized by the patient achieves a corresponding treatment goal in compliance with the guidelines.

22. The system according to claim 21, wherein if the treatment strategy utilized by the patient does not achieve the corresponding treatment goal, the processor displays at least one reason in compliance with the guidelines as to why the patient is not achieving the goal.

23. The system according to claim 20, wherein the processor displays at least one assessment associated with one disease entity based on prior entered information associated with another disease entity.

24. The method according to claim 20, wherein the processor receives information associated with the patient, the information including at least one of a result from an echocardiogram, a result from a nuclear ventriculogram, a result from a cardiac catheterization, and a fitness data.

25. A computer-readable storage medium storing a set of instructions, the set of instructions capable of being executed by a processor to facilitate treatment of a patient by a health care provider, the set of instructions performing the steps of:
(a) providing a first user interface to the health care provider;
(b) providing a second user interface to the patient;
(c) receiving information associated with the patient via the first user interface in response to a medical visit with the health care provider;
(d) providing a treatment goal specific to the patient via the second user interface based upon the received information.

26. A computer-readable storage medium storing a set of instructions, the set of instructions capable of being executed by a processor to manage clinical practice for a health care practitioner, the set of instructions performing the steps of:
(a) electronically receiving an indication of a disease entity associated with a patient; and
(b) displaying at least one treatment strategy associated with the disease entity in compliance with guidelines recommended by recognized governing bodies.
